(19) United States
(12) Patent Application Publication
(10) Pub. No.: US 2008/0236906 A1
(43) Pub. Date: Oct. 2, 2008

(54) Stylus Retention for an Industrial Portable Electronic Device

(76) Inventors: Ji Woei Amos Foo, Singapore (SG); Yen Jason Chin, Singapore (SG); Tze Wei Henry Wong, Singapore (SG); Ah Hock Law, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/088,178

(22) PCT Filed: Sep. 30, 2005
(86) PCT No.: PCT/SG2005/000331

§ 371 Date: Mar. 26, 2008

(51) Int. Cl. G06F 3/033

(52) U.S. Cl. 178/19.01

(57) ABSTRACT

A portable electronic device comprising a stylus for use with a touch screen of said portable electronic device; a storage portion for storing the stylus; said stylus comprising a grip at a first end of the stylus; an elongate portion connected to the grip, said elongate portion having a contacting end for engaging the touch screen of the portable electronic device; said elongate portion adapted to slide into the storage portion of the portable electronic device in order to store said stylus with said device; said portable electronic device including an engagement means for maintaining the stylus in the stored position; said engagement means including at least one resiliently deformable portion a recess, and; a projection wherein; the stylus is maintained in position through engagement of the recess and projection and released by application of force to the at least one resiliently deformable portion sufficient to deform said portion so as to effect relative movement of the projection and recess and so permit removal of the stylus.

### FIELD OF THE INVENTION

The invention relates to portable electronic devices, such as PDAs, used in an industrial environment whereby robustness of design is required for avoidance of damage through detritus forming in said PDA, or incidental damage caused through normal industrial use.

### BACKGROUND

Electronic devices used in an industrial environment must show a high degree of robustness not required of normal devices for commercial or domestic use. In such environments, chemicals, dust and moisture dramatically shorten the life of equipment if not adequately protected.

As suggested, electronic devices which are designed for normal commercial or domestic applications do not have the required robustness to survive in such environments for any practical or economic length of time. For this reason, equivalent devices for use in industrial environments must be modified to meet the demands of that industrial environment which include construction sites, factory floor and chemical processing plants.

An issue for such devices in an industrial environment is the retention of the stylus used for a PDA, or other portable electronic device, having a touch screen application. The efficiency provided by a touch screen outweighs the shortened life that such a screen may have in such an environment. To limit incidental damage to the screen, having the correct equipment to use with the touch screen is extremely important. Thus, a stylus designed for use with an electronic touch screen should always be available with the device so as to avoid operators using inappropriate equipment on the electronic touch screen. Thus maintaining the stylus with the device is important to maintain the life of the device.

Typically, commercial and domestic devices maintain the stylus in position using a spring-loaded engagement with the barrel of the stylus.

In one example, the stylus may have a circumferential groove adjacent to the conical end of the stylus used for contacting the electronic screen. To hold the stylus in place, a spring-loaded projection engages with the groove to hold it in place, often with the conical end of the stylus engaging the storage area in a morse taper-type engagement.

This arrangement for storing the stylus in a device designed for a commercial or domestic environment is useful, but lacks practicality for an industrial environment whereby interstitial spaces between the stylus and the storage area may easily become clogged with dust and other detritus.

Further, any spring-loaded arrangement will deteriorate quickly when subjected to this same detritus and moisture.

It is therefore an object of the present invention to simplify the design for the stylus retention as compared to the prior art.

### STATEMENT OF INVENTION

In one aspect of the invention provides a portable electronic device comprising

a stylus for use with a touch screen of said portable electronic device; a storage portion for storing the stylus; said stylus comprising: a grip at a first end of the stylus;
an elongate portion connected to the grip, said elongate portion having a contacting end for engaging the touch screen of the portable electronic device; said elongate portion adapted to slide into the storage portion of the portable electronic device in order to store said stylus with said device; said portable electronic device including an engagement means for maintaining the stylus in the stored position; said engagement means including at least one resiliently deformable portion a recess, and;
a projection wherein;

the stylus is maintained in position through engagement of the recess and projection and released by application of force to the at least one resiliently deformable portion sufficient to deform said portion so as to effect relative movement of the projection and recess and so permit removal of the stylus.

By combining a resiliently deformable material, a spring force may be applied to the stylus in order to hold it in place. Further, a considerable amount of material will need to be clogged in the storage portion before this arrangement no longer functions in a practical sense. Therefore, the invention is considerably more robust and applicable to an industrial environment as compared to the prior art.

In a preferred embodiment, the shape of the projection and the recess may be such that the stylus is self-guided into the desired position as it approaches engagement between the projection and the recess.

In a preferred embodiment, the stylus may include the project, for co-operating with the recess located in the storage portion. Alternatively, the projection may be located in the storage portion, with the recess positioned in the stylus.

In a preferred embodiment, the storage portion may include a resiliently deformable portion. In a further preferred embodiment, the stylus may include a resiliently deformable portion. In a more preferred embodiment, both the stylus and storage portion may include such deformable portions.

In a preferred embodiment, the arrangement between the recess and the projection may be such that when the stylus is in the stored position, an application of force firstly towards the stylus and then outward from the storage portion will deform the recess such that the stylus is easily removable without having to overcome the applied spring force.

In a second aspect, the invention provides a stylus for use with a touch screen of a portable electronic device; said stylus comprising: a grip at a first end of the stylus;
an elongate portion connected to the grip, said elongate portion having a contacting end for engaging the touch screen of the portable electronic device; said elongate portion adapted to slide into a storage portion of the portable electronic device in order to store said stylus with said device, and; at least a portion of an engagement means for co-operation with a remaining portion of the engagement means located on the storage portion, said engagement means comprising a projection, a corresponding recess and at least one resiliently deformable portions wherein;

the stylus is maintained in position through engagement of the recess and projection and released by application of force to the at least one resiliently deformable portion sufficient to deform said portion so as to effect relative movement of the projection and recess and so permit removal of the stylus.

### BRIEF DESCRIPTION OF DRAWINGS

FIG. 1a-c show a detailed view of the stylus and electronic device according to one embodiment of the present invention;

FIG. 2 shows a cross-section of the stylus and portable electronic device and the direction of force required for removal according to the embodiment of FIG. 1;

FIG. 3 shows a detailed elevation view of the engaging means according to one embodiment of the present invention.

FIGS. 4a to 4d show detailed views of the removal of the stylus of FIG. 3.

It will be convenient to further describe the present invention with respect to the accompanying drawings, which illustrate possible arrangements of the invention. Other arrangements of the invention are possible and consequently, the particularity of the accompanying drawings is not to be understood as superceding the generality of the preceding description of the invention.

### DESCRIPTION OF PREFERRED EMBODIMENT

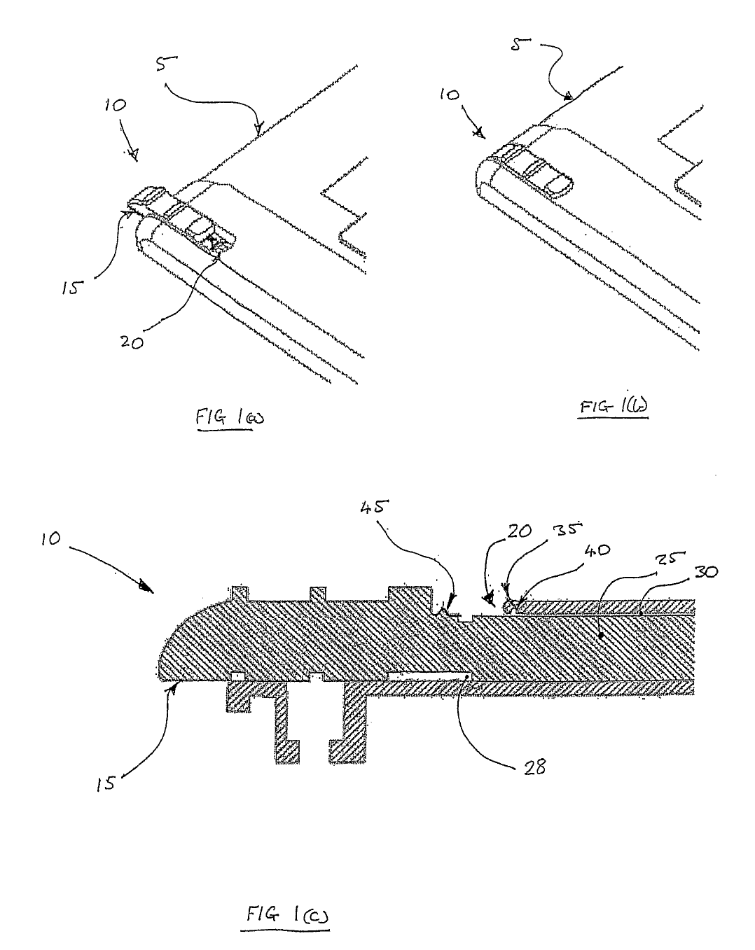

FIGS. 1a-c show the portable electronic device 5 and in particular, that portion of the device 5 used to retain the stylus 10 whilst not in use. The stylus 10 comprises a grip 15 attached to an elongate shaft 25 forming a pencil-shaped device. The stylus 10 being used for interfacing with the device 5 through contact with a touch screen (not shown) is developed to have sufficient rigidity to function as a pencil, but of particular materials and shape so as not to cause damage to the touch screen (not shown).

Thus, having the stylus 10 in close proximity to the device 5 is important for maintaining the functional life of the screen. To this end, the portable electronic device includes a storage portion 30 into which the barrel 25 of stylus 10 may slide. In this embodiment, the electronic device 5 provides a recess 20 to accommodate the grip 15 of the stylus 10 when the stylus 10 is fully engaged with the storage portion 30 as shown in FIG. 1b.

In this embodiment the stylus 10 includes a projection 45 on the shaft 25 adjacent to grip 15. The projection 45 is arranged to point outwards from the device 5 whilst inserting the stylus into the storage portion 30. The projection 45 is further adapted to fit into a corresponding recess 40 located within a wall of the storage portion such that when the stylus 10 is fully inserted into the storage portion 30 as shown in FIG. 1b, the projection 45 engages with the recess 40 so as to hold the stylus in place. Thus, the stylus is maintained in engagement with the portable electronic device 5 through an interference fit between the projection 45 of the stylus 10 and the wall 35 of the portable electronic device 5.

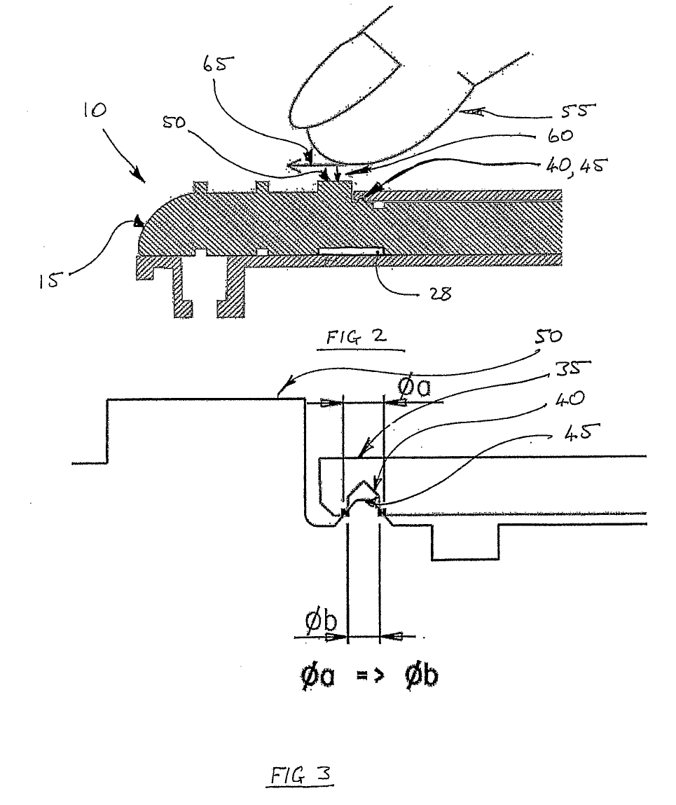

With reference to FIG. 2 in one embodiment, release of the stylus 10 from the storage portion 30 is achieved by application of force 60,65 by a user to the stylus 10 and the device 5. A user may press down with a finger 55 at an abutment 50 of the stylus 10. By first pressing down 60 and deforming the abutment 35 of the device 5 and the deformable portion 28 of the stylus 10 and then pushing outward 65 on the abutment 50, the interference fit caused by the projection 45 and the recess 40 is removed, or at least decreased, permitting free removal of the stylus 10. Suitable materials for the deformable portions 28, 35 include a wide range of polymers, such as, but not restricted to ABS, polypropylene and polycarbonate.

In this embodiment, the intent of the application of force to the abutment 50 is to minimize the distance between the line of action of the thumb and the interlocking projection/recess. This may reduce wear and also the degree of deformation, and so extend the working life of the device.

In a further embodiment, FIG. 3 shows the relationship of the size of the recess 40 to the contact portion of the projection 45. In this embodiment, the relative shapes of the projection 45 and recess 40 is such that when adjacent to the engaged position, the stylus is self-guided due to a spring force applied to the inclined face of the projection 45 by the resiliently deformable portion 35 via contact with the recess 40. Thus insertion of the stylus 10 does not need to be exactly to position, but merely close enough for the self-guiding mechanism to activate, and so reduced chance of loss of the stylus 10 through in attention of the user.

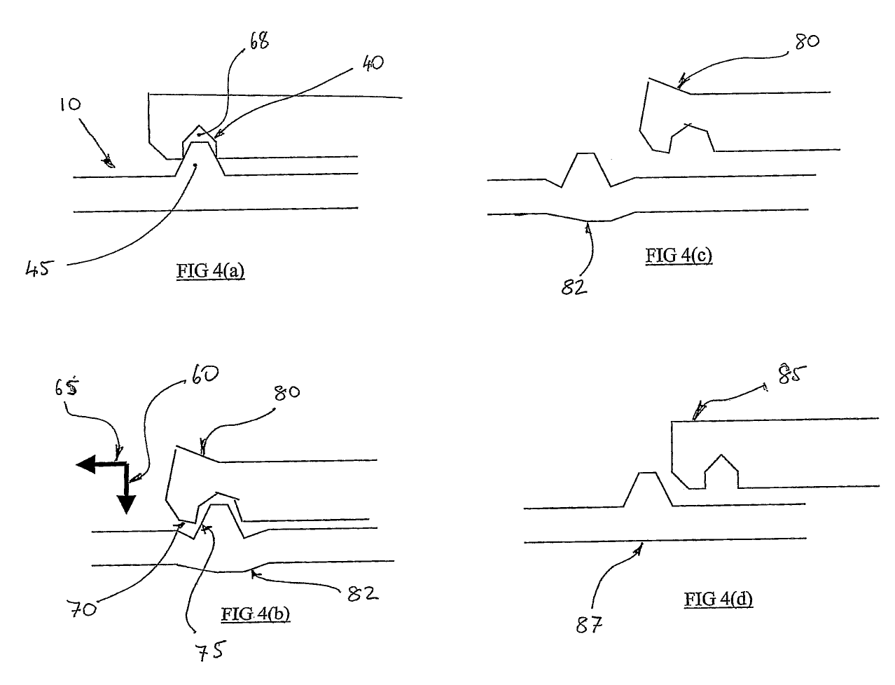

The effect of this sizing between the recess and the projection is shown in FIGS. 4a to 4d. In FIG. 4a, the projection 45 is engaged with the recess 40. In this engagement, the projection is not fully within the recess, but there exists a gap 68 between the projection 45 and recess 40 in the normal engaged position. Application of load 60 to the abutment 50, pushes the recess 40 further down the projection and so closing the gap 68, as well as deforming the deformable portion 82 of the stylus 10. Because the projection 45 is frusto-conical in shape, the leading edges 70 of the recess 40 contact and progress down the inclined faces 75 of the frusto-conical projection 45. The inclined faces 75 increase the opening of the recess 40, acting like a wedge, leading to a deformation of the deformable portion 80, as well as a corresponding deformation 82 of the stylus. On release of the downward force 60, the deformable portions 80, 82 maintain the deformed shape permitting an outward force 65 to slide the stylus 10 out of the storage portion 30. Because the deformable portions 80, 82 are of materials that recover their shape quickly after the application of force 60 is removed, the deformable portions 80, 82 resume their previous shapes 85, 87 ready for re-engagement of the stylus within the storage portion 30.

It should be noted that, in this embodiment, deformation 82 of the stylus 10 is greater than that of the storage portion 80. Because the stylus 10 is more easily replaced that the casing of the device, then fatigue that may occur from frequent use is better directed to the stylus 10. It will be appreciated by the skilled addressee, however, that the relative proportion of deformation, falling within the invention includes all deformation by the stylus and no deformation by the storage portion, to full deformation of the storage portion and none by the stylus, and proportional deformation of these two elements between these extremes.

Thus, the combination of the frusto-conical projection 45, the gap 68 within the recess 40 and the deformable materials of the deformable portions 80, 82 permit engagement and release of the stylus from the storage portion 30 without the need for moving parts which may become clogged or, for tight tolerances, may be compromised by the build up of detritus within the storage portion 30. Thus, this engagement arrangement is better suited to an industrial environment where dust, dirt and moisture are prevalent as compared to the arrangements used for similar devices designed for domestic or commercial use.

That which is claimed:

1. A portable electronic device comprising:
a stylus for use with a touch screen of said portable electronic device;
a storage portion for storing the stylus;
said stylus comprising:
a grip at a first end of the stylus;
an elongate portion connected to the grip, said elongate portion having a contacting end for engaging the touch screen of the portable electronic device;
said elongate portion adapted to slide into the storage portion of the portable electronic device in order to store said stylus with said device;
said portable electronic device including an engagement means for maintaining the stylus in the stored position;
said engagement means including at least one resiliently deformable portion, a recess, and a projection;
wherein the stylus is maintained in position through engagement of the recess and projection and released by application of force to the at least one resiliently deformable portion sufficient to deform said portion so as to effect relative movement of the projection and recess and so permit removal of the stylus.

2. The device according to claim 1 wherein the projection is located on the stylus, and the recess is located on the storage portion.

3. The device according to claim 1 wherein the projection is located on the storage portion, and the recess is located on the stylus.

4. The device according to claim 1, wherein the stylus comprises the at least one resiliently deformable portion.

5. The device according to claim 1, wherein the storage portion comprises the at least one resiliently deformable portion.

6. The device according to claim 1, wherein in the engaged position, the at least one resiliently deformable position applies a spring force to the projection and recess to maintain the stylus in the stored position.

7. The device according to claim 1, wherein the recess and projection are shaped to self-guide the projection from a position adjacent to the stored position to the stored position through application of the spring force of the at least one resiliently deformable portion.

8. The device according to claim 1, wherein in the engaged position a peripheral portion of the projection and the recess define an expansion cavity.

9. The device according to claim 1, wherein the recess is cone shaped and the projection is frusto-conical shaped.

10. The device according to claim 1, wherein the at least one resiliently deformable portion comprises a polymer.

11. A stylus for use with a touch screen of a portable electronic device, said stylus comprising:
a grip at a first end of the stylus;
an elongate portion connected to the grip, said elongate portion having a contacting end for engaging the touch screen of the portable electronic device;
said elongate portion adapted to slide into a storage portion of the portable electronic device in order to store said stylus with said device; and
at least a portion of an engagement means for co-operation with a remaining portion of the engagement means located on the storage portion, said engagement means comprising a projection, a corresponding recess and at least one resiliently deformable portions;
wherein the stylus is maintained in position through engagement of the recess and projection and released by application of force to the at least one resiliently deformable portion sufficient to deform said portion so as to effect relative movement of the projection and recess and so permit removal of the stylus.
